(19) United States
(12) Patent Application Publication
(10) Pub. No.: US 2026/0054727 A1
(43) Pub. Date: Feb. 26, 2026

(54) DRIVE ASSIST DEVICE

(71) Applicant: TOYOTA JIDOSHA KABUSHIKI KAISHA, Toyota-shi (JP)

(72) Inventor: Hiroki AIKAWA, Ebina-shi (JP)

(73) Assignee: TOYOTA JIDOSHA KABUSHIKI KAISHA, Toyota-shi (JP)

(21) Appl. No.: 19/210,269

(22) Filed: May 16, 2025

(30) Foreign Application Priority Data
Aug. 22, 2024 (JP) 2024-140619

(51) Int. Cl. B60W 30/17; B60W 10/06; B60W 10/184; B60W 30/16; B60W 30/18

(52) U.S. Cl. CPC B60W 30/17; B60W 10/06; B60W 10/184; B60W 30/162; B60W 30/18127; B60W 30/18136; B60W 2554/4045; B60W 2554/4049; B60W 2710/06; B60W 2710/18; B60W 2720/106

(57) ABSTRACT

When the preceding vehicle is stopped in front of the traffic light, the lighting color of the traffic light is “green”, the other vehicle is not stopped immediately before the preceding vehicle, the direction indicating light of the preceding vehicle is off, and the distance between the host vehicle and the preceding vehicle at the time when the preceding vehicle is detected exceeds a threshold value, the processor controls the predetermined device so that the host vehicle travels at a constant speed, or controls the predetermined device of the host vehicle so that the speed of the host vehicle decreases in the second mode that is slower than the first mode.

### CROSS-REFERENCE TO RELATED APPLICATION

This application claims priority to Japanese Patent Application No. 2024-140619 filed on Aug. 22, 2024. The disclosure of the above-identified application, including the specification, drawings, and claims, is incorporated by reference herein in its entirety.

### BACKGROUND

### 1. Technical Field

The present disclosure relates to a drive assist device that controls a driving device and/or a braking device of a host vehicle such that a vehicle-to-vehicle distance between the host vehicle and another vehicle (preceding vehicle) agrees with a target value when the preceding vehicle is present immediately ahead of the host vehicle.

### 2. Description of Related Art

There is proposed a drive assist device that controls a driving device and/or a braking device of a host vehicle such that a vehicle-to-vehicle distance between the host vehicle and a preceding vehicle agrees with a target value (see, for example, Japanese Unexamined Patent Application Publication No. 2006-264571 (JP 2006-264571 A)). This drive assist device (hereinafter referred to as “related-art device”) controls the driving device and/or the braking device (hereinafter referred to as “driving device etc.”) of the host vehicle such that the host vehicle decelerates and stops behind the preceding vehicle while the preceding vehicle is stopped (stationary).

### SUMMARY

While the preceding vehicle is stopped, the related-art device determines a target value of the deceleration of the host vehicle (target value of the rate of decrease in speed) based on the vehicle-to-vehicle distance between the host vehicle and the preceding vehicle (current value) and the speed of the host vehicle (current value). Then, the related-art device controls the driving device etc. such that the deceleration of the host vehicle (current value) agrees with the determined target value. A scene is assumed in which the preceding vehicle is stopped behind a traffic light and the lighting color of the traffic light is “green” (immediately after the lighting color has changed to “green”). In this scene, the driver of the host vehicle approaching the preceding vehicle from behind the preceding vehicle is highly likely to predict that the preceding vehicle will start soon. In this case, the driver is highly likely to predict that the driver can safely drive the host vehicle without causing the host vehicle to excessively approach the preceding vehicle even if the host vehicle is not decelerated so greatly. In this case, the driver is highly likely to expect that the host vehicle will be controlled by the drive assist device such that the host vehicle is decelerated relatively slowly.

The related-art device determines the target value of the deceleration of the host vehicle based on the distance between the host vehicle and the preceding vehicle and a relative speed (speed of the host vehicle in the scene) regardless of the lighting color of the traffic light. Therefore, in the scene in which the preceding vehicle is predicted to start soon, the deceleration of the host vehicle may increase contrary to the expectation (prediction) of the driver of the host vehicle.

An object of the present disclosure is to provide a drive assist device that can suppress control (deceleration control) on a host vehicle that is contrary to expectation (prediction) of a driver of the host vehicle in a specific scene.

In order to achieve the above object, a drive assist device (1) of the present disclosure includes:
a vehicle sensor (20) configured to acquire information (sp0) on a host vehicle (V0) and information (spr, D) on an object (V1, V2, S) located ahead of the host vehicle; and
a processor (10) configured to execute a speed adjustment process (ACC) for controlling a predetermined device (30, 40) of the host vehicle such that a vehicle-to-vehicle distance (D) between the host vehicle and a preceding vehicle that is another vehicle located immediately ahead of the host vehicle agrees with a predetermined target value (Dt), the processor being configured to start, as the speed adjustment process, a first process for controlling the predetermined device such that the host vehicle decelerates in a predetermined first mode when a stopped preceding vehicle is detected.

The processor is configured to, when
(A) the preceding vehicle is at a standstill behind a traffic light,
(B) a lighting color of the traffic light is green,
(C) no other vehicle is at a standstill immediately ahead of the preceding vehicle,
(D) a direction indication light of the preceding vehicle is off, and
(E) a distance between the host vehicle and the preceding vehicle at a time when the preceding vehicle is detected exceeds a threshold value,
start a second process as an alternative to the first process, the second process including a process of controlling the predetermined device such that the host vehicle travels at a constant speed, or a process of controlling the predetermined device such that a speed of the host vehicle decreases more slowly in a second mode than in the first mode.

As described above, in a specific scene in which a preceding vehicle at a standstill ahead of the host vehicle is predicted to start soon, the driver of the host vehicle is highly likely to predict that the host vehicle can safely travel even if the host vehicle is not decelerated so greatly. The processor of the drive assist device according to the present disclosure executes the process of causing the host vehicle to travel at a constant speed or the process of slowly decelerating the host vehicle when a condition for determining that the preceding vehicle is highly likely to start soon is satisfied. According to the present disclosure, it is possible to suppress control (rapid deceleration) on the host vehicle that is contrary to expectation (prediction) of the driver of the host vehicle in the specific scene.

In the drive assist device according to an aspect of the present disclosure, the processor is configured to assign a larger value to the threshold value as the speed of the host vehicle increases.

In a situation where the host vehicle is approaching the preceding vehicle considerably at the time when the processor detects the preceding vehicle, the risk of contact between the host vehicle and the preceding vehicle is high if the second process is started from that time. In particular, if the second process is started from the time when the preceding vehicle is detected while the host vehicle is traveling at a relatively high speed, the risk of contact between the preceding vehicle and the host vehicle is high. The processor of the drive assist device according to the present aspect can start the second process only if the distance between the preceding vehicle and the host vehicle is relatively large when the host vehicle is traveling at a relatively high speed. Therefore, according to the drive assist device of the present aspect, it is possible to reduce the risk of contact between the host vehicle and the preceding vehicle.

In the drive assist device according to another aspect of the present disclosure, the processor is configured to terminate the second process when a predetermined period (Tx) has elapsed since a start of the second process.

The preceding vehicle may continue to stop after the processor has started the second process. If the processor continues to execute the second process in this situation, the host vehicle may excessively approach the preceding vehicle. In the drive assist device according to the present aspect, a period in which the processor can continue the second process is limited. That is, the processor terminates the second process when the predetermined period has elapsed since the start of the second process. If the preceding vehicle has not yet started at this time, the processor may start the first process from this time. Thus, the risk of contact between the host vehicle and the preceding vehicle is reduced.

In the drive assist device according to another aspect of the present disclosure, the processor is configured to terminate the second process when entry of another vehicle between the preceding vehicle and the host vehicle is detected while the second process is being executed.

In this configuration, when another vehicle enters between the host vehicle and the preceding vehicle, the processor terminates the second process and controls the host vehicle such that the vehicle-to-vehicle distance between the host vehicle and the other vehicle agrees with the target value. Thus, the risk of contact between the host vehicle and the other vehicle is reduced.

In the drive assist device according to another aspect of the present disclosure, the processor is configured to:
execute, as the first process, a process of decelerating the host vehicle by operating a friction brake; and
execute, as the second process, a process of decelerating the host vehicle by operating an engine brake or a regenerative brake.

With the drive assist device of the present aspect, the riding comfort of the host vehicle during the period in which the second process is being executed is better than the riding comfort of the host vehicle during the period in which the first process is being executed.

### BRIEF DESCRIPTION OF THE DRAWINGS

Features, advantages, and technical and industrial significance of exemplary embodiments of the disclosure will be described below with reference to the accompanying drawings, in which like signs denote like elements, and wherein:

FIG. 1 is a block diagram of a drive assist device according to an embodiment of the present disclosure;

FIG. 2 is a graph showing a speed change (first mode) of the host vehicle in a specific first scene;

FIG. 3 is a graph showing the speed change (second mode) of the host vehicle in a particular second scene; and

FIG. 4 is a flow chart of a program executed by CPU to implement the vehicle-to-vehicle distance keeping function.

### DETAILED DESCRIPTION OF EMBODIMENTS

### Overview

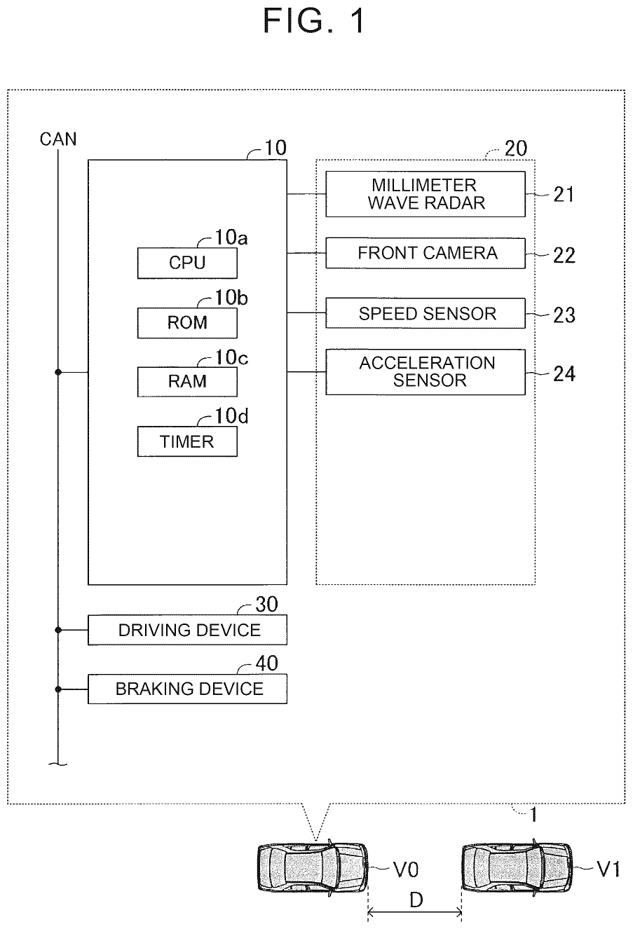

As illustrated in FIG. 1, the drive assist device 1 according to an embodiment of the present disclosure is applied to a vehicle V0 (hereinafter, referred to as a “host vehicle”) having an automated driving function. The drive assist device 1 has a function of controlling the host vehicle (the driving device 30 and/or the braking device 40) such that the vehicle-to-vehicle distance D between the host vehicle and another vehicle V1 (hereinafter, referred to as “preceding vehicle”) located immediately before the host vehicle coincides with a predetermined target value Dt in a state in which the autonomous driving function is disabled. Note that the control may be executed as one function of the autonomous driving function.

### Specific Configuration

As illustrated in FIG. 1, the drive assist device 1 includes an ECU 10, an in-vehicle sensor 20, a driving device 30, and a braking device 40.

ECU 10 includes a microcomputer with a CPU 10a, ROM 10b, RAM 10c, timer 10d, etc. ECU 10 is connected to other ECUs of the host vehicle via a controller area network (CAN).

The in-vehicle sensor 20 includes a front sensor for acquiring information about the preceding vehicle. Specifically, the in-vehicle sensor 20 includes a millimeter wave radar 21 as a front sensor and a front camera 22.

The millimeter wave radar 21 includes a transmission/reception unit and a signal processing unit (not shown). The transmission and reception unit radiates a millimeter-wave band radio wave (hereinafter, referred to as “millimeter wave”) toward the front of the host vehicle, and receives a millimeter wave (reflected wave) reflected by a three-dimensional object (preceding vehicle) located within the radiation range. The millimeter wave radiated from the transmission and reception unit passes under the floor of the preceding vehicle and is reflected by a three-dimensional object (another vehicle V2) located in front of the preceding vehicle. The transmitting and receiving unit receives the reflected wave. The signal processing unit calculates the distance between the host vehicle and the three-dimensional object, the speed of the host vehicle with respect to the three-dimensional object, and the like on the basis of the time from the emission of the millimeter wave by the transmitting/receiving unit until the reception of the reflected wave, the phase difference between the transmitted millimeter wave and the received reflected wave, the attenuation level of the reflected wave, and the like. The three-dimensional object is, for example, a preceding vehicle and another vehicle located in front of the preceding vehicle. The speed of the host vehicle with respect to the three-dimensional object is the relative speed of the host vehicle with respect to the three-dimensional object. The signal-processing unit provides these computations to ECU 10.

The front camera 22 includes an imaging device and an image analysis device. Imaging devices incorporate imaging elements such as lenses, CCD (charge coupled device) or CIS (CMOS image sensor). The imaging device is directed forward at an upper portion of the windshield glass. The imaging device captures a foreground of the host vehicle at a predetermined frame rate, and acquires image data. The imaging device transmits the image data to the image analysis device. The image analysis device analyzes the acquired image data and acquires information about an object located in front of the host vehicle from the image. For example, the image-analysis device identifies (recognizes) the type of the object located in front of the host vehicle, and provides the identification result to ECU 10. The type of the target object is (for example, a preceding vehicle, a lane mark, a lighting color of a traffic light, an operating state of a direction indicating light of the preceding vehicle, and the like). The operating states of the direction indication lights of the preceding vehicle are the blinking of the right direction indication lights, the blinking of the left direction indication lights, the blinking of the bidirectional indication lights, and the turning off of the bidirectional indication lights.

In addition, the in-vehicle sensor 20 includes a vehicle sensor that acquires information on the behavior (speed and acceleration) of the host vehicle. Specifically, the in-vehicle sensor 20 includes a speed sensor 23 and an acceleration sensor 24 as vehicle sensors.

The speed sensor 23 detects the rotational speed (wheel speed) of each wheel, and calculates the speed sp0 (measured value) of the host vehicle based on each wheel speed. The speed sensor 23 provides the calculation result to ECU 10.

The acceleration sensor 24 detects the longitudinal acceleration (the rate of change α in the speed sp0) of the host vehicle. The acceleration sensor 24 provides the sensing to ECU 10.

The driving device 30 applies a driving force to the driving wheels. The driving device 30 includes an engine ECU, an internal combustion engine, a transmission, a drive force transmission mechanism that transmits the drive force to the wheels, and the like. The engine ECU acquires information (target value) representing a target driving force from another ECU (for example, an ECU 10). The engine ECU drives a throttle valve of the internal combustion engine so that a driving force applied to the driving wheels matches a target value. The output (driving force) of the internal combustion engine is transmitted to the drive wheels via the transmission and the driving force transmission mechanism.

When the vehicle to which the drive assist device 1 is applied is a hybrid electric vehicle (HEV), the engine ECU can adjust the power (driving force) of one or both of the “internal combustion engine and the electric motor” as the vehicle driving source. When the vehicle to which the drive assist device 1 is applied is an electric vehicle (BEV), an electric motor ECU that adjusts an output (driving force) of an “electric motor” as a vehicle driving source is used instead of the engine ECU.

The braking device 40 is a friction brake device that applies a braking force (friction force) to a wheel (brake disc). The braking device 40 includes a brake ECU, a brake caliper, and the like. The brake caliper includes an actuator that presses a brake pad against a brake disc. The brake ECU acquires information (target value) representing a target braking force from another ECU. The brake ECU drives an actuator of the brake caliper so that a braking force applied to the wheel (brake disc) matches a target value.

### Operation

When ACC switch (not shown) mounted on the host vehicle is in the on-state, ECU 10 determines whether or not the preceding vehicle is present, and controls the driving device 30 and/or the braking device 40 (such as the driving device) of the host vehicle based on the determination result, as will be described below. This control is commonly referred to as adaptive cruise control (ACC). ACC includes constant speed travel control and vehicle-to-vehicle distance keeping control.

### Constant Speed Driving Control

ECU 10 determines the presence or absence of the preceding vehicles based on the data acquired from the front sensors (the millimeter-wave radar 21 and the front camera 22). When the preceding vehicles do not exist, ECU 10 executes constant speed travel control. Specifically, ECU 10 controls the driving device or the like so that the speed sp0 of the host vehicle matches a predetermined target value spt (for example, a value set by the driver or a speed value at which the fuel-consumption rate becomes lowest). Even if the preceding vehicle is present, if the speed sp1 is larger than the target value spt, ECU 10 executes the constant speed travel control.

### Vehicle-to-Vehicle Distance Keeping Control

When it is determined that the preceding vehicles exist, ECU 10 executes the vehicle-to-vehicle distance keeping control. Specifically, ECU 10 acquires, from the in-vehicle sensor 20, a distance (vehicle-to-vehicle distance D) between the host vehicle and the preceding vehicle, a relative speed spr, and a speed sp0 of the host vehicle. ECU 10 also obtains speed sp1 of the preceding vehicles. Further, ECU 10 calculates (determines) a target value Dt of the vehicle-to-vehicle distance D based on the speed sp1. When the speed sp1 is relatively small, the target value Dta is smaller than the target value Dtb when the speed sp1 is relatively large. A data base DB1 (table) representing the relation between the speed sp1 and the target value Dt is stored in ROM 10b. ECU 10 refers to the data base DB1 and acquires the target value Dt.

ECU 10 controls the driving device or the like of the host vehicle so that the vehicle-to-vehicle distance D (actual measurement value) coincides with the target value Dt and the speed sp0 coincides with the speed sp1. ECU 10 controls the driving device or the like so that the rate of change α of the speed sp0 of the host vehicle becomes “0” at the time when the speed sp0 coincides with the speed sp1.

More specifically, ECU 10 refers to the data base DB2 stored in advance in ROM 10b to determine a target value αt of a change rate α (increase rate or decrease rate) of the speed sp0 of the host vehicle. Then, ECU 10 controls the driving device or the like so that the rate of change α matches the target value αt. Here, the data base DB2 defines the relation between the “vehicle-to-vehicle distance D (measured value) and the difference ΔD between the target value Dt”, and the relative speed spr (speed sp0 and speed sp1) and the “target value αt”. When the target value αt is larger than “0”, the host vehicle is accelerated, and when the target value αt is smaller than “0”, the host vehicle is decelerated.

For example, the data base DB2 is designed as follows. When the vehicle-to-vehicle distance D is excessively large (ΔD>0) and the relative speed spr is excessively large (sp0>sp1), a negative value having a large absolute value is assigned to the target value αt so that the speed sp0 approaches the speed sp1 relatively rapidly. Further, for example, when the vehicle-to-vehicle distance D is excessively large (ΔD>0) and the relative speed spr is excessively small (sp0<sp1), a positive value having a large absolute value is assigned to the target value αt so that the speed sp0 once exceeds the speed sp1. Further, for example, when the vehicle-to-vehicle distance D is slightly larger than the target value Dt (D≈Dt) and the relative speed spr is slightly larger than “0”, a negative value having a small absolute value is assigned to the target value αt so that the reduction rate of the speed sp0 becomes relatively small. Further, for example, when the vehicle-to-vehicle distance D is slightly larger than the target value Dt (D≈Dt) and the relative speed spr is slightly smaller than “0”, a positive value having a small absolute value is assigned to the target value αt so that the increase rate of the speed sp0 becomes relatively small.

Further, for example, when the vehicle-to-vehicle distance D is too small (ΔD<0) and the relative speed spr is too large (sp0>sp1), a negative value having a large absolute value is assigned to the target value αt so that the speed sp0 is once below the speed sp1. Further, for example, when the vehicle-to-vehicle distance D is too small (ΔD<0) and the relative speed spr is too small (sp0<sp1), a positive value having a large absolute value is assigned to the target value αt so that the speed sp0 approaches the speed sp1 relatively rapidly. Further, for example, when the vehicle-to-vehicle distance D is slightly smaller than the target value Dt (D≈Dt) and the relative speed spr is slightly larger than “0”, a negative value having a small absolute value is assigned to the target value αt so that the reduction rate of the speed sp0 becomes relatively small. Further, for example, when the vehicle-to-vehicle distance D is slightly smaller than the target value Dt (D≈Dt) and the relative speed spr is slightly smaller than “0”, a positive value having a small absolute value is assigned to the target value αt so that the increase rate of the speed sp0 becomes relatively small.

Next, an aspect of a change in the vehicle-to-vehicle distance D and the speed sp0 due to the execution of the vehicle-to-vehicle distance keeping control when the preceding vehicle is stopped (stationary) will be described.

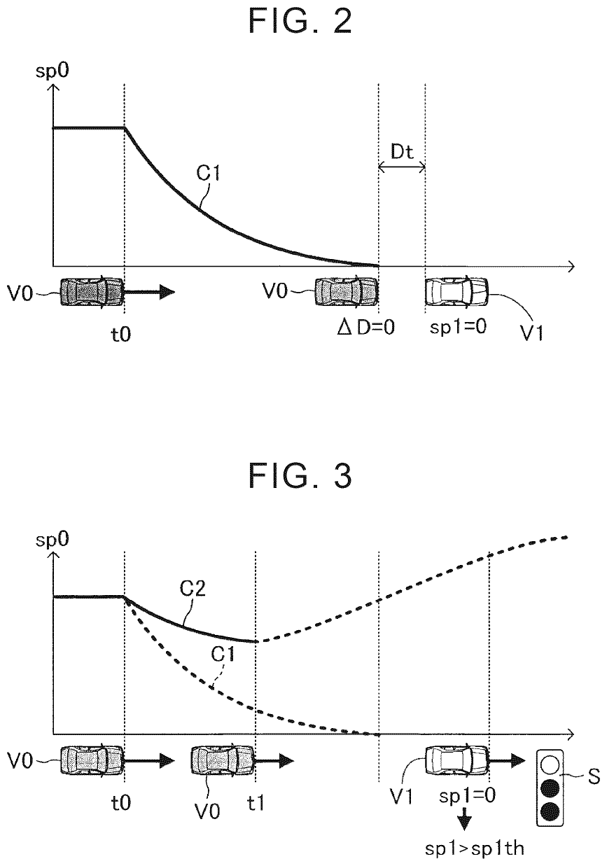

FIG. 2 illustrates a situation in which a preceding vehicle (another vehicle V1) is stopped for some reason. In this scenario, the host vehicle (vehicle V0) is approaching the preceding vehicle from the rear of the preceding vehicle. On the basis of the information acquired from the in-vehicle sensor 20, ECU 10 acquires the speed sp1 of the preceding vehicle on the basis of the information at a time point t0 when it is determined that the preceding vehicle exists in front of the host vehicle. Next, ECU 10 determines a target value Dt (target value of the vehicle-to-vehicle distance D) corresponding to the speed sp1. In this case, since the speed sp1 is “0”, the target value Dt is relatively small. Further, in this embodiment, the vehicle-to-vehicle distance D is larger than the target value Dt at the time point t0 when ECU 10 detects the preceding vehicle. Further, as described above, the target value Dt is determined in accordance with the speed sp1 of the preceding vehicle, and therefore, the target value Dt does not change while the preceding vehicle continues to stop.

In this embodiment, the speed sp0 of the host vehicle is relatively large at the time point t0 when ECU 10 detects the preceding vehicle. Therefore, ECU 10 controls the driving device or the like so that the rate of reduction of the speed sp0 is relatively large. Thereafter, ECU 10 gradually brings the rate of reduction of the speed sp0 closer to “0” as the vehicle-to-vehicle distance D decreases. When the vehicle-to-vehicle distance D coincides with the target value Dt (ΔD=0) and the speed sp0 becomes “0 ” (=sp1), the reduction rate of the speed sp0 becomes “0”. In the following explanation, a mode of a change in the speed sp0 of the host vehicle (the speed change curve C1 illustrated in FIG. 2) caused by the execution of the vehicle-to-vehicle distance keeping control when the preceding vehicle is stopped is referred to as a “first mode”. Further, a process in which ECU 10 controls the driving device or the like so that the speed change is realized is referred to as a “first process”.

In FIG. 2, when the preceding vehicle is started before the vehicle-to-vehicle distance D is decreased and matches the target value Dt, ECU 10 sequentially updates the target value Dt based on the speed sp1 of the preceding vehicle. Each time the target value Dt is updated, ECU 10 refers to the data base DB2 and acquires the target value αt of the change rate α. Then, ECU 10 controls the driving device or the like so that the change rate α (present value) coincides with the target value αt (normal process).

Incidentally, as shown in FIG. 3, ECU 10 detects a preceding vehicle stopping in front of the traffic light S, and at that time point t0, a scene in which the lighting color of the traffic light S is “green” is assumed. In this scene, the driver of the host vehicle is likely to predict that the preceding vehicle will start soon. In this case, the driver is likely to predict that the driver can safely drive the host vehicle without excessively approaching the preceding vehicle even if the host vehicle is not decelerated so much. Then, the driver is likely to expect the driving device or the like to be controlled so that the host vehicle is decelerated in the second mode (the speed change curve C2 in FIG. 3) which is slower than the first mode.

Therefore, as will be described below, ECU 10 determines whether or not the host vehicle can safely proceed even if the host vehicle is not decelerated so much when the preceding vehicle that is stopping in front of the host vehicle is detected (success or failure of the condition X). Then, ECU 10 executes a second process of controlling the driving device or the like so that the host vehicle is decelerated in a second mode that is slower than in the first mode when the condition X is satisfied.

Here, even if the light color of the traffic light S is “green”, it may take some time for the preceding vehicle stopping in front of the traffic light S to start. For example, when the other vehicle V2 is stopped immediately before the preceding vehicle, it is highly likely that the preceding vehicle is stopped until the other vehicle V2 starts and the vehicle-to-vehicle distance between the other vehicle V2 and the preceding vehicle increases to some extent. Further, for example, even when there is no other vehicle V2 in front of the preceding vehicle, there is a case where the preceding vehicle turns left or right (a case where the left-side direction indicator light or the right-side direction indicator light is blinking). At this time, there is a possibility that the pedestrian or another vehicle traveling on the oncoming lane may wait until the other vehicle passes.

Further, in some cases, the host vehicle is approaching the preceding vehicle considerably t0 the time when ECU 10 detects the preceding vehicle. For example, in a case where the road is largely curved in front of the traffic light S, it is highly likely that the vehicle-to-vehicle distance D is considerably reduced at the time point when the host vehicle detects the preceding vehicle that is stopping. In this case, when ECU 10 slowly decelerates the host vehicle from the time t0 when the preceding vehicle is detected, the host vehicle and the preceding vehicle are highly likely to touch each other. In particular, when the host vehicle is slowly decelerated in a situation where the speed sp0 of the host vehicle at the time point t0 is relatively large, the host vehicle and the preceding vehicle are highly likely to come into contact with each other.

Therefore, ECU 10 determines that the condition X is satisfied when the conditions A to E below are satisfied at the time point t0 when the preceding vehicles are detected.
Condition A . . . The preceding car is stopped in front of the traffic light S.
Condition B . . . The light color of traffic light S is “green”.
Condition C . . . Preceding vehicles stop independently.
Condition D . . . The turn indication light of the preceding car is off.
Condition E . . . Vehicle-to-vehicle distance D exceeds the threshold Dth.

ECU 10 determines that the preceding vehicle is stopped (stationary) when the speed sp1 of the preceding vehicle is less than or equal to the minute threshold sp1th. In addition, ECU 10 determines a value to be assigned to the threshold Dth in accordance with the speed sp0 of the host vehicle at the time point t0. Specifically, ECU 10 assigns a larger value to the threshold Dth as the speed sp0 at the time point t0 increases.

When the condition X is satisfied, ECU 10 starts the second process. That is, ECU 10 controls the driving device or the like so that the host vehicle is decelerated in the second mode (the speed change curve C2) that is slower than the first mode (the speed change curve C1). Specifically, ECU 10 assumes that the preceding vehicles continue to stop, and sequentially refers to the data base DB2 to acquire the target value αt. Each time the target value αt is acquired, ECU 10 corrects the target value αt as follows. That is, ECU 10 obtains a value obtained by multiplying the target value αt obtained from the data base DB2 by a predetermined factor k (e.g., k=“0.5”) as the corrected target value αt. Then, ECU 10 controls the driving device or the like so that the rate of change α (present value) of the speed sp0 matches the corrected target value αt.

ECU 10 may activate the braking device 40 (frictional braking) in the first process. In contrast, ECU 10 may activate the engine brake (or regenerative brake) in the second process.

ECU 10 executes the second process until a time t1 at which the time Δt elapsed from the time t0 at which the second process is started reaches a predetermined threshold Tx. Here, the threshold Tx is set in advance as a normal time (for example, 3 seconds) required for a time from when the light color of the traffic light S transitions from “red” to “green” until the preceding vehicle starts and the speed sp1 of the preceding vehicle increases to some extent. Even if the preceding vehicles start during the time, ECU 10 continues the second process. As described above, as one of the conditions under which ECU 10 executes the second process, a condition E is provided in which the vehicle-to-vehicle distance D between the host vehicle and the preceding vehicle is sufficiently large. Therefore, there does not occur a situation in which the host vehicle is excessively approaching the preceding vehicle during the execution of the second process. ECU 10 sequentially updates, from the time point t1, the target value Dt based on the speed sp1 of the preceding vehicle, and controls the driving device or the like so that the vehicle-to-vehicle distance D matches the updated target value Dt and the speed sp0 of the host vehicle matches the speed sp1 at that time point. In the embodiment illustrated in FIG. 3, the host vehicle is accelerated from the time point t1, but in some cases, the host vehicle is controlled to be continuously decelerated (first process) or the host vehicle is controlled to proceed at a constant speed in accordance with the behavior of the preceding vehicle. When another vehicle enters between the preceding vehicle and the host vehicle while ECU 10 is executing the second process, ECU 10 ends the second process at that time. Then, ECU 10 recognizes the other vehicle and the host vehicle as a new preceding vehicle, and then executes ACC.

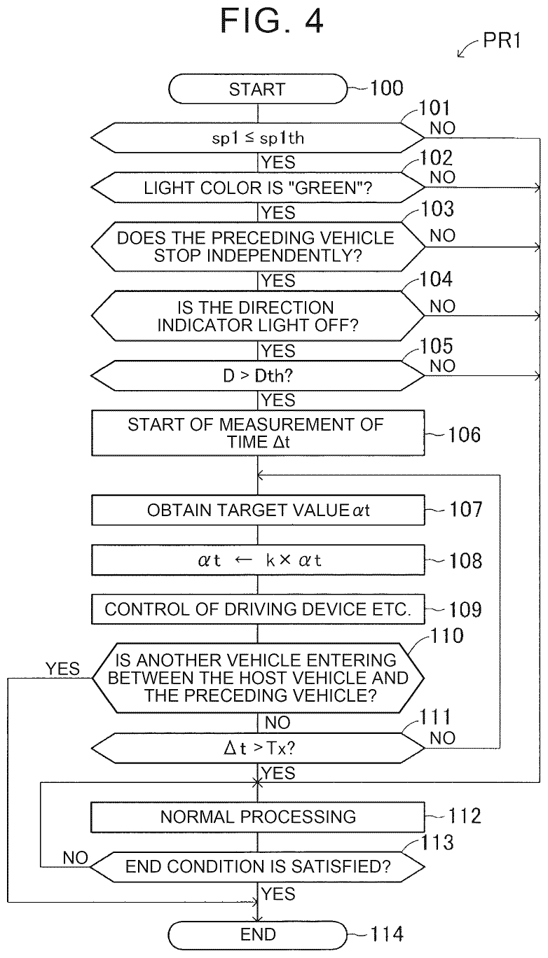

Next, referring to FIG. 4, a programming PR1 executed by a CPU 10a (hereinafter simply referred to as “CPU”) in order to realize the vehicle-to-vehicle distance keeping function of the drive assist device 1 will be described.

CPU executes the programming PR1 at a time point t0 when ACC switch is in the on-state and the preceding vehicle is detected.

### Programming PR1

CPU starts executing the programming PR1 from step 100 and proceeds to step 101.

In step 101, CPU determines whether or not the speed sp1 is equal to or less than the threshold sp1th (whether or not the preceding vehicle is stopped). If CPU determines that the preceding vehicles are stopping (101: Yes), the process proceeds to step 102. On the other hand, if CPU does not determine that the preceding vehicles are stopping (101: No), the process proceeds to step 112, which will be described later.

In step 102, CPU determines whether or not the light color of the traffic light S is “green”. If CPU determines that the light color of the traffic light S is “green” (102: Yes), the process proceeds to step 103. On the other hand, if CPU does not determine that the light color of the traffic light S is “green”(102: No), the process proceeds to step 112.

In step 103, CPU determines whether or not the preceding vehicles are solely stopped. If CPU determines that the preceding vehicles are stopping alone (103: Yes), the process proceeds to step 104. On the other hand, if CPU does not determine that the preceding vehicles are stopping independently (103: No), the process proceeds to step 112.

In step 104, CPU determines whether or not the turn indication lights of the preceding vehicles are off. If CPU determines that the direction-indicating light of the preceding vehicles is off (104: Yes), the process proceeds to step 105. On the other hand, if CPU does not determine that the direction-indicating light of the preceding vehicles is turned off (104: No), the process proceeds to step 112.

In step 105, CPU determines whether or not the vehicle-to-vehicle distance D exceeds the threshold Dth. If CPU determines that the vehicle-to-vehicle distance D exceeds the threshold Dth (105: Yes), the process proceeds to step 106. On the other hand, if it is not determined that the vehicle-to-vehicle distance D exceeds the threshold Dth (105: No), CPU proceeds to step 112.

CPU causes the timer 10d to begin measuring the duration Δt at step 106. CPU then proceeds to step 107.

In step 107, CPU refers to the data base DB2 and acquires (updates) the target value αt corresponding to the difference ΔD and the relative speed spr. CPU then proceeds to step 108.

CPU corrects the target αt in step 108. That is, CPU acquires the value obtained by multiplying the target value αt acquired in step 107 by the coefficient k as the corrected target value αt. CPU then proceeds to step 109.

In step 109, CPU controls the driving device or the like so that the rate of change α of the speed sp0 of the host vehicle matches the target value αt (corrected value). CPU then proceeds to step 110.

In step 110, CPU determines whether another vehicle has entered between the host vehicle and the preceding vehicle. If CPU determines that another vehicle has entered between the host vehicle and the preceding vehicle (110: Yes), the process proceeds to step 114 described later. On the other hand, if CPU does not determine that the other vehicle has entered between the host vehicle and the other vehicle (110: No), the process proceeds to step 111.

CPU determines whether the duration Δt exceeds a threshold Tx at step 111. If CPU determines that the period Δt exceeds the threshold Tx (111: Yes), it proceeds to step 112. On the other hand, if CPU does not determine that the period Δt exceeds the threshold Tx (110: No), the process returns to step 107.

CPU performs a normal process at step 112. That is, CPU refers to the data base DB2 to acquire the target value αt, and controls the driving device or the like so that the rate of change α matches the target value αt. CPU then proceeds to step 113.

In step 113, CPU determines whether a predetermined termination condition is satisfied. For example, when the preceding vehicle cannot be detected, the speed sp1 of the preceding vehicle exceeds the target value spt. If it is determined that the termination condition is satisfied (113: Yes), CPU proceeds to step 114. On the other hand, if it is not determined that the termination condition is satisfied (113: No), CPU returns to step 111.

CPU terminates executing the programming PR1 in step 114.

### Effect

As described above, in a specific scene in which a preceding vehicle stopping in front of the host vehicle is predicted to start soon, it is highly likely that the driver of the host vehicle can predict that the host vehicle can safely proceed without decelerating the host vehicle. ECU 10 controls the driving device and the like so that the host vehicle decelerates in the second mode, which is slower than the first mode, when the condition X for determining that the leading vehicle is likely to start soon is satisfied. According to this, it is possible to suppress the control (sudden deceleration) of the host vehicle that is contrary to the expectation (prediction) of the driver of the host vehicle in the specific scene.

### Modification

In the vehicle-to-vehicle distance keeping control, the rate of change α of the speed sp0 in the process in which the vehicle-to-vehicle distance D approaches the target value Dt may be constant. In the second process, the rate of change α in the speed sp0 may be “0”. That is, ECU 10 may cause the host vehicle to travel at a constant speed sp0 in the second process.

What is claimed is:

1. A drive assist device comprising:
a vehicle sensor configured to acquire information on a host vehicle and information on an object located ahead of the host vehicle; and
a processor configured to execute a speed adjustment process for controlling a predetermined device of the host vehicle such that a vehicle-to-vehicle distance between the host vehicle and a preceding vehicle that is another vehicle located immediately ahead of the host vehicle agrees with a predetermined target value, the processor being configured to start, as the speed adjustment process, a first process for controlling the predetermined device such that the host vehicle decelerates in a predetermined first mode when a stopped preceding vehicle is detected, wherein
the processor is configured to, when
the preceding vehicle is at a standstill behind a traffic light,
a lighting color of the traffic light is green,
no other vehicle is at a standstill immediately ahead of the preceding vehicle,
a direction indication light of the preceding vehicle is off, and
a distance between the host vehicle and the preceding vehicle at a time when the preceding vehicle is detected exceeds a threshold value,
start a second process as an alternative to the first process, the second process including a process of controlling the predetermined device such that the host vehicle travels at a constant speed, or a process of controlling the predetermined device such that a speed of the host vehicle decreases more slowly in a second mode than in the first mode.

2. The drive assist device according to claim 1, wherein the processor is configured to assign a larger value to the threshold value as the speed of the host vehicle increases.

3. The drive assist device according to claim 2, wherein the processor is configured to terminate the second process when a predetermined period has elapsed since a start of the second process.

4. The drive assist device according to claim 3, wherein the processor is configured to terminate the second process when entry of another vehicle between the preceding vehicle and the host vehicle is detected while the second process is being executed.

5. The drive assist device according to claim 1, wherein the processor is configured to:
execute, as the first process, a process of decelerating the host vehicle by operating a friction brake; and
execute, as the second process, a process of decelerating the host vehicle by operating an engine brake or a regenerative brake.
